(19) United States
(12) Patent Application Publication
(10) Pub. No.: US 2007/0080579 A1
(43) Pub. Date: Apr. 12, 2007

(54) Apparatus and method for indicating parking brake non-engagement

(76) Inventor: David B. Steinbring, Johnstown, PA (US)

Correspondence Address: FLOYD B. CAROTHERS;CAROTHERS AND CAROTHERS, 445 FORT PITT BOULEVARD, SUITE 500, PITTSBURGH, PA, 15219, US

(21) Appl. No.: 11/247,679

(22) Filed: Oct. 11, 2005

(51) Int. Cl. B60T 13/00

(52) U.S. Cl. 303/6.1

(57) ABSTRACT

A parking brake engagement indicator for a parking brake system on a commercial truck wherein an indicator bar is mounted on the truck and is moveable between a position of impediment between the driver's outside lower leg portion and the driver's side exit doorframe of the truck, to a second position of non-impediment. The indicator bar is connected to the parking brake system whereby the bar is manipulated by the brake system itself to the position of impediment when the parking brake is disengaged and the bar is manipulated by the brake system to the position of non-impediment when the parking brake is engage.

### BACKGROUND OF THE INVENTION

The present invention relates generally to a braking systems, and more particularly to a safety indicator for parking brake systems which indicates to the driver of a commercial truck that the parking brake is not engaged.

A severe safety hazzard has arisen with regard to the application of parking brakes on commercial trucks which make frequent stops or pickup, such as delivery trucks and waste hauling trucks or garbage trucks. These trucks generally have pneumatically operated parking brake systems which the drivers are required to engage each time they leave the truck cab to make a pickup, a rest stop, or for other purposes. As a result severe accidents have occurred wherein the unattended vehicle rolls away creating severe damage and even resulting sometimes in severe injury or death to pedestrians.

Various systems have been developed over the years in an attempt to avoid this problem. For example, one system, such as shown in U.S. Pat. No. 6,758,298, automatically applies the parking brake when the driver's not seated. However, this is problematic as a driver might momentarily rise, or be caused to rise from the driver's seat thereby inappropriately activating the system and of course such a system would not work in the truck cabs wherein no seat is provided for the driver and the driver is always in a standing position. For example, this is sometimes the situation with short delivery route trucks. Another system prevents the vehicle door from opening until the parking brake is set. For example, see U.S. Pat. No. 4,546,845. This reference applies to train doors, but nevertheless, even if incorporated in a truck this could be disastrous in an accident situation wherein the driver would be prevented from escaping from the vehicle.

U.S. Pat. No. 6,234,525 discloses a driver restraint device in the form of a pivoting bar that acts as a safety harness belt. The safety belt restraining device is configured to release the parking brake as a function of the position of the bar/seatbelt combination. Such a device simply is not practical for trucks wherein the driver must make frequent exits from the cab, such as is the situation for waste pickup trucks.

Accordingly, it is a principal object of the present invention to provide a system which definitely reminds the operator of the truck to set the parking brake for exiting the vehicle, yet does not hinder an escape from the cab in the event of an emergency, and further provides a system which is devoid of the aforementioned disadvantages.

### SUMMARY OF THE INVENTION

The present invention provides an apparatus and method for definitely indicating to the driver of a commercial truck that the parking brake is not engaged. The indicator is comprised of a bar mounted on the truck, wherein the bar is moveable between a position of impediment between the driver's outside lower leg portion and the driver's side exit doorframe of the truck, and a second position of non-impediment. The bar is connected to the parking brake system whereby the bar is manipulated by the brake system itself in the position of impediment when the parking brake is disengaged, and the bar is manipulated by the brake system to the position of non-impediment when the parking brake is engaged.

In a pneumatically operated brake system, after the vehicle is started and air pressure has built up and the parking brake plunger or actuator is in the D-actuated position, air is supplied to air canisters that release the parking brake on the rear wheels of the vehicle, and at the same time air under pressure is also supplied to an air cylinder motor operating the indicator bar causing the bar to be biased to the position of impediment. When the parking brake plunger knob is pulled out on the vehicle dash board to actuate the parking brake, air under pressure is then cutoff and no longer supplied to the brake canisters. The spring loaded parking brake then engages with the rear wheels making the vehicle immobile and since no air is being supplied also to the operating cylinder for the indicator bar if pivoted, drops to the vertical position or if horizontally extended is retracted under spring bias.

Accordingly, the operator of the commercial truck is positively reminded by the impeding bar that the parking brake has not been set when attempting to exit the cab, yet the impediment of the bar is such that it does not prevent the operator from escaping from the vehicle in the event of an accident.

### BRIEF DESCRIPTION OF THE DRAWINGS

Other objects and advantages appear hereinafter in the following description and claims. The accompanying drawings show, for the purpose of exemplification, without limiting the invention or appended claims, certain practical embodiments of the present invention wherein:

FIG. 1 shows one embodiment of the parking brake engagement indicator of the present invention; and

FIG. 2 shows a second embodiment of the indicator of the present invention.

### DETAILED DESCRIPTION OF THE PREFERRED EMBODIMENTS

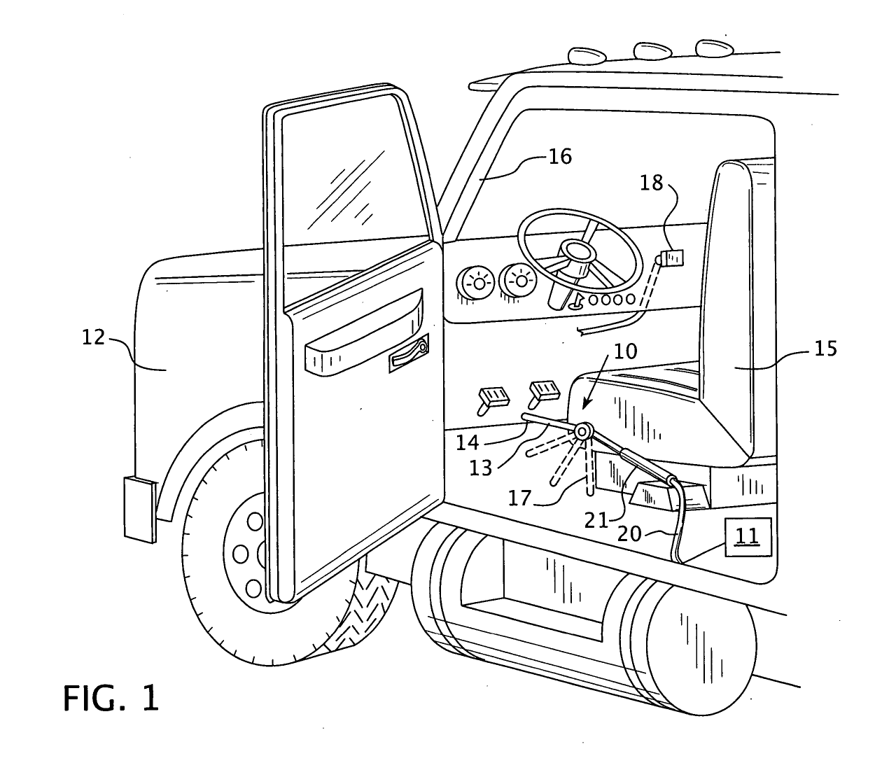

Referring to FIG. 1, the parking brake engagement indicator 10 for parking brake system 11, which is schematically illustrated, on the commercial truck 12 is comprised of an indicator bar 13 mounted on the truck wherein bar 13 is pivotally moveable between a position of impediment 14 between a driver's outside leg portion (not shown) when seated in the driver's seat 15, and driver's side exit doorframe 16 of truck 12, and to a second position of non-impediment as indicated at 17.

The parking brake system 11 is of a conventional type which is pneumatically operated and the pneumatically operated parking brake 11 is engaged by pulling out plunger 18 on the dashboard of the truck 12. When the parking brake system 11 is not actuated, air under pressure is supplied to pneumatic motor cylinder 21 which moves and maintains bar to and in the position of impediment 13. However, when the parking brake system 11 is engaged by pulling plunger 18, air under pressure is released through conduit 20 from the motor cylinder 21 which causes the bar 13 to pivotally drop from its position of impediment 14 to its position of non-impediment 17.

When bar 13 is in the position of impediment as indicated at 14 it is adjacent the lower portion of driver's leg somewhere between knee level and ankle level. Thus when the operator attempts to leave the cab of the truck 12, his lower leg engages the bar 13 thereby providing him a positive reminder that he must first apply the parking brake. Nevertheless, in the case of an emergency, the driver is still able to escape the vehicle cab by stepping over the bar 13 in its position of impediment 14.

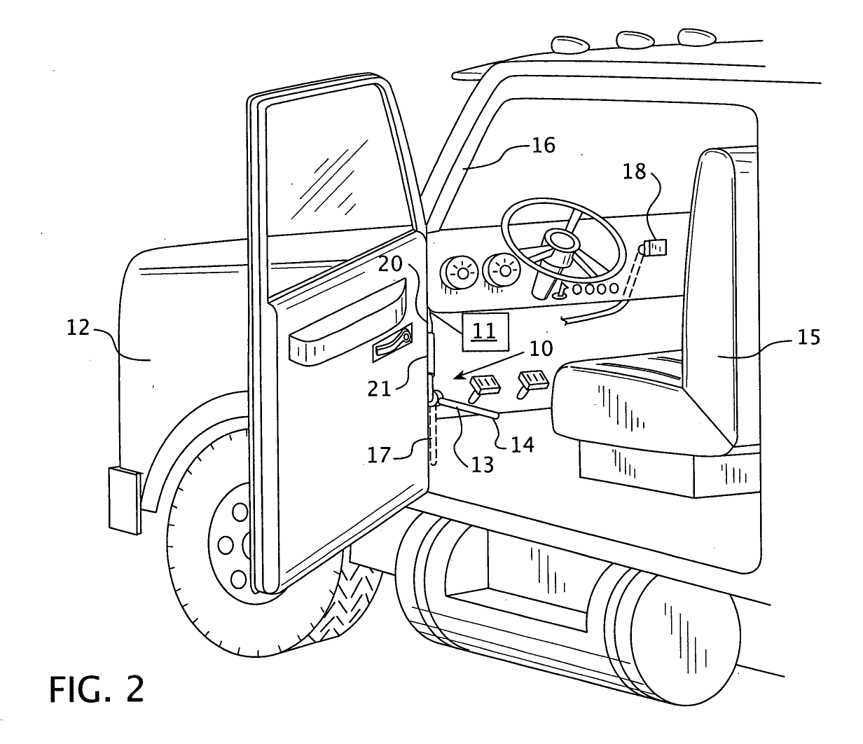

The configuration shown in FIG. 2 operates in a identical manner, however in this situation the bar 13 is pivoted adjacent the firewall of the cab, instead of being pivoted adjacent the seat frame of the cab. As an alternative, the bar 13 need not be pivoted but may instead be mounted whereby it horizontally projects or protrudes outwardly to the position of impediment 14 and then horizontally retracts under spring bias to a position of non-impediment.

1. A parking brake engagement indicator for a parking brake system on a commercial truck, the indicator comprising:
a bar mounted on the commercial truck, wherein the bar is movable between a position of impediment between an occupant's outside lower leg portion and an occupant's side exit doorframe of said truck, and a position of non-impediment;
the bar being connected to the parking brake system whereby said bar is manipulated by said brake system to the position of impediment when said parking brake is disengaged and said bar is manipulated by said brake system to the position of non-impediment when said parking brake is engaged.

2. The parking brake indicator of claim 1, wherein said parking brake system is pneumatically operated.

3. The parking brake indicator of claim 2, wherein said bar is biased by pneumatic pressure to the position of impediment when pneumatic pressure in the parking brake system is above a predetermined minimum.

4. The parking brake indicator of claim 1, wherein said bar is pivotally mounted on the truck.

5. A method for indicating to an occupant of a commercial truck that the parking brake of a parking brake system for the truck is not engaged, the method comprising;
mounting a bar on the truck whereby the bar is movable between a position of impediment between the occupant's outside lower leg portion and occupant's side exit doorframe of said truck, and a position of non-impediment; and
manipulating said bar to the position of impediment by said parking brake system when said parking brake is disengaged.

6. The method of claim 5, wherein said bar is pneumatically manipulated.

7. The method of claim 6, wherein said bar is biased by pneumatic pressure to the position of impediment when pneumatic pressure in the parking brake system is above a predetermined minimum.

8. The method of claim 5, wherein said bar is pivotally manipulated from one position to the other.
